(19) United States
(12) Patent Application Publication
(10) Pub. No.: US 2015/0175841 A1
(43) Pub. Date: Jun. 25, 2015

(54) Fire-Resistant Coating and Wood Products

(71) Applicant: WEYERHAEUSER NR COMPANY, Federal Way, WA (US)

(72) Inventors: Erik M. Parker, Bonney Lake, WA (US); Glen Robak, Meridian, ID (US); Jack G. Winterowd, Puyallup, WA (US)

(73) Assignee: WEYERHAEUSER NR COMPANY, Federal Way, WA (US)

(21) Appl. No.: 14/138,618

(22) Filed: Dec. 23, 2013

(51) Int. Cl. C09D 175/08; C08K 3/04; C08K 3/22

(52) U.S. Cl. CPC C09D 175/08; C08K 3/2279; C08K 3/04; C08K 2003/045

(57) ABSTRACT

The present disclosure provides formulations that provide fire resistance when applied as a coating to a surface (e.g., the surface of a wood product). The compositions include an isocyanate, a brominated compound that is reactive with the isocyanate to form a polyurethane, an intumescent component, and a fire-retardant synergist. Wood products treated with the composition, as well as methods for applying the composition to a surface, are also provided.

### TECHNICAL FIELD

The present disclosure is directed generally to fire-resistant wood products and formulations for fire-resistant coatings.

### BACKGROUND

One way to improve the fire-safety of buildings is to follow construction guidelines for fire prevention and damage mitigation, which include detailed recommendations regarding structural design, assemblies, sprinkler systems, smoke detectors, and other factors influencing how a fire might start and spread throughout a building. In addition, companies that manufacture building materials from wood have taken steps to make their products inherently more fire-safe. Some companies have experimented with coating or impregnating wood products with fire-retardant chemical treatments. Examples of such treatments are described in U.S. Pat. Nos. 6,245,842 and 5,968,669, the disclosures of which are hereby incorporated by reference in their entirety.

For wood products used in construction there are two main tests used to qualify wood products as fire-resistant materials in the building codes. The first test is the ASTM E119 fire endurance test, which measures the ability of the product to maintain its load bearing capacity during a fire. The second test is the ASTM E2768 flame spread test, which requires a 30-minute burn on an ASTM E84 flame spread test set-up. The E2768 test measures the ability of the material to resist or slow the propagation of a flame along its surface. Coatings that perform well in one of these tests do not necessarily perform well in the other. For example, a coating that is relatively non-combustible may prevent the spread of a flame along its surface, but may do very little to protect the substrate from heat degradation. Such a coating would perform well in the E84 test but perform poorly in an E119 test. Conversely, a coating that rapidly expands when exposed to heat or flame may not prevent a flame from traveling along its surface.

In the interest of greater fire safety, there is a need in the construction industry to develop improved coatings for wood products that enhance fire endurance properties, as well as slow the propagation of flame along its surface.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect a fire-resistant formulation for a wood product is provided. In one embodiment the composition includes a polyurethane matrix comprising:

an isocyanate, wherein the isocyanate is present in a quantity ranging from 15% to 40% by mass of the formulation;

a brominated compound that is reactive with the isocyanate to form a polyurethane, wherein the brominated compound is present from about 10% to 80% by mass of the formulation;

an intumescent component, wherein the intumescent component is present in a quantity ranging from 1% to 25% by mass of the formulation; and

a fire-retardant synergist, wherein the synergist is present in a quantity ranging from 0.25% to 15% by mass of the formulation.

In another aspect, a fire-resistant wood product is provided. In one embodiment, the wood product comprises:

a wood product having one or more surfaces; and

a fire-resistant formulation as provided herein disposed on at least a portion of the one or more surfaces.

In another aspect, a fire-resistant I-joist formed from one or more wood products is provided. In one embodiment, the I-joist comprises:

a top flange;

a bottom flange; and

one or more webstock members connecting the top flange to the bottom flange;

wherein at least a portion of the I-joist is coated in a fire-resistant formulation disclosed herein.

In one embodiment, 50% to 100% of the wood product's surface is coated in the fire-resistant formulation.

Further aspects include methods for applying the composition (e.g., as a coating on a surface of a wood product).

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1 and 2 are side cross sectional views of I-joists coated with a composition according to embodiments of the disclosure; and

FIGS. 3 and 4 are side cross sectional views of wood products coated with a composition according to embodiments of the disclosure.

### DETAILED DESCRIPTION

The present disclosure provides compositions formulated to provide fire resistance when applied as a coating to a surface (e.g., the surface of a wood product). The compositions include an isocyanate, a brominated compound that is reactive with the isocyanate to form a polyurethane, an intumescent component, and a fire-retardant synergist. Wood products treated with the composition, as well as methods for applying the composition to a surface, are also provided.

Polyurethanes are typically used with wood products for water resistance but are very flammable. Accordingly, fire retardants are added to them to reduce their flammability. Therefore, forming a fire-resistant coating from a polyurethane for a combustible substrate (e.g., a wood product) goes against the conventional teachings regarding both polyurethane coatings and fire-resistant coatings. Not only do the disclosed embodiments provide fire-resistant coatings, but certain embodiments have been shown to achieve a 30 minute rating in the E-84 test. The provided combination of water resistance, extreme flame spread performance, and fire endurance properties are a rare combination for a coating and extremely difficult to achieve.

Certain specific details are set forth in the following description and FIGURES to provide a thorough understanding of various embodiments of the disclosure. Well-known structures, systems, and methods often associated with such systems have not been shown or described in detail to avoid unnecessarily obscuring the description of various embodiments of the disclosure. In addition, those of ordinary skill in the relevant art will understand that additional embodiments of the disclosure may be practiced without several of the details described below. Certain terminology used in the disclosure is defined as follows:

“Wood product” is used to refer to a product manufactured from logs, such as lumber (e.g., boards, dimension lumber, solid sawn lumber, joists, headers, beams, timbers, moldings, laminated, finger jointed, or semi-finished lumber), composite wood products, or components of any of the aforementioned examples.

“Composite wood product” is used to refer to a range of derivative wood products which are manufactured by binding together the strands, particles, fibers, or veneers of wood, together with adhesives, to form composite materials. Examples of composite wood products include but are not limited to glulam, plywood, parallel strand lumber (PSL), oriented strand board (OSB), oriented strand lumber (OSL), laminated veneer lumber (LVL), laminated strand lumber (LSL), particleboard, medium density fiberboard (MDF), cross-laminated timber, and hardboard.

“Intumescent particles” refer to materials that expand in volume and char when they are exposed to fire.

The term “about” is used herein to modify a related value by +/−5%.

When applied to wood products, the provided compositions also provide improved fire resistant properties. As used herein, the term “fire resistance” refers to a treated state of the wood product wherein the treated wood product is less susceptible to burning. In some embodiments the improved fire resistance of the product can be measured using the E84 test. Any improvement over an untreated product in this test is considered improved fire resistance. An increase in time to ignition when the treated product is exposed to a flame compared to an untreated product is another way to measure an improvement in fire resistance. In certain embodiments, the composition provides fire-retardant-treated (FRT) qualification of the wood product based on the extended E-84 (30 min.) test for fire-retardant-treated wood (International Building code §2303.2).

When applied to wood products, the provided compositions also provide low flame-spread properties. As used herein, the term “low flame-spread” refers to a treated state of the wood product wherein the wood product is rated at least Class A (10 minute burn) using the E84 test. In certain embodiments, the composition provides FRT qualification of the wood product based on the E2768 (30 min.) fire-retardant-treated wood (International Building code §2303.2).

Flame-spread ratings are given in the E84 test. There are A, B and C ratings as well as a Class A with a 20 minute extension. The provided composition as a coating on a wood product is designed to meet the Class A flame spread with the additional 20 minute extension so that it can be equivalent to fire retardant treated wood. For class A, the flame cannot travel more than 10.5 feet in a 10 minute period. For the 20 minute extension the flame cannot travel past 10.5 feet in 30 minutes. Some of the embodiments of the provided composition as a coating on a wood product are designed to meet the fire-retardant-treated wood rating. Section 2303.2 of the International Building Code states that fire-retardant-treated wood shall have a listed flame spread index of 25 or less and show no evidence of significant progressive combustion when the test is continued for an additional 20-minute period. In addition, the flame front shall not progress more than 10.5 feet beyond the centerline of the burners at any time during the test. Other embodiments may provide a lower level of fire resistance by providing a Class A rating or a reduced time to ignition.

Turning now to the compositions, in one aspect a fire-resistant formulation for a wood product is provided. In one embodiment the composition includes a polyurethane matrix comprising:

an isocyanate, wherein the isocyanate is present in a quantity ranging from 15% to 40% by mass of the formulation;

a brominated compound that is reactive with the isocyanate to form a polyurethane, wherein the brominated compound is present from about 10% to 80% by mass of the formulation;

an intumescent component, wherein the intumescent component is present in a quantity ranging from 1% to 25% by mass of the formulation; and

a fire-retardant synergist, wherein the synergist is present in a quantity ranging from 0.25% to 15% by mass of the formulation.

The components of the provided compositions will now be described. Unless noted otherwise, the percentages listed for particular components are based on the total mass of the formulation.

Isocyanate

The isocyanate and the brominated compound react to form a polyurethane, which provides a hardened matrix after formulation as a liquid. In one embodiment, the isocyanate is present in a quantity ranging from 20% to 35% by mass of the total formulation.

In one embodiment, the isocyanate is an aromatic isocyanate selected from the group consisting of toluene diisocyanate (TDI), monomeric methylene diphenyldiisocyanate (MDI), polymeric methylenediphenyldiisocyanate (pMDI), 1,5′-naphthalenediisocyante, prepolymers of TDI, and prepolymers of pMDI.

In one embodiment, the isocyanate is an aliphatic isocyanate selected from the group consisting of hexamethylene diisocyanate (HDI) and isophorone diisocyanate (IPDI).

Brominated Compound

The brominated compound is reactive with the isocyanate to form a polyurethane with brominated moieties incorporated within the polymer matrix. This reduces the risk of the bromine or brominated compound leaching into the environment. Because the bromine is part of the polymer it is released at the temperatures that the polymer degrades so it is released into the combustion process at the optimum time.

In one embodiment, the brominated compound is present from about 15% to 30% by mass of the formulation. In one embodiment, the brominated compound is present from about 15% to 25% by mass of the formulation.

In one embodiment the brominated compound is a polyol. In one embodiment, the brominated compound is selected from the group consisting of tetrabromophthalate diol, brominated neopentyl alcohol, and brominated neopentyl glycol.

Intumescent Component

The disclosed compositions also include an intumescent component, which improves fire resistance. The intumescent particles expand during a fire event and create a barrier layer that protects the substrate from heat and slows the migration of combustible gases to the flame front and inhibits the flow of oxygen to the burning substrate.

In one embodiment, the intumescent component is present in a quantity ranging from 5% to 25% by mass of the formulation. In one embodiment, the intumescent component is present in a quantity ranging from 10% to 25% by mass of the formulation.

In one embodiment, the intumescent component is selected from the group consisting of expandable graphite, perlite ore, and vermiculite ore.

Fire-Retardant Synergist

The fire-retardant synergist provides additional fire resistance to the formulation by reducing the amount of bromine needed to achieve a given level of fire performance. In the case of antimony compounds, the antimony reacts with bromine radicals in the condensed phase forming volatile complexes which can then migrate into the gas phase and react with H and OH radicals and interrupt the free radical flame propagation mechanism. The addition of an antimony synergist then prevents the bromine from being trapped in the condensed phase where it is less effective. Synergists other than antimony may provide benefits via a different mechanism or mechanisms.

In one embodiment, the fire-retardant synergist is present in a quantity ranging from 1% to 10% by mass of the formulation. In one embodiment, the fire-retardant synergist is present in a quantity ranging from 1% to 5% by mass of the formulation.

In one embodiment, the fire-retardant synergist is selected from the group consisting of hallosite clay (e.g., Dragonite, Applied Minerals), antimony trioxide, antimony pentaoxide, colloidal antimony pentoxide, sodium antimonite, antimony carbonate, antimony sulfate, or antimony hydroxide, or other antimony-metal compounds, antimony compounds that contain silicone or phosphorous, zinc hydroxy stannate, and mixtures thereof. Synergists can also include salts of boron-containing acids and bromine-containing amines. An example of a boron-containing acid is boric acid. Examples of bromine-containing amines include 1-bromoaniline and a resin prepared from m-bromophenol, m-phenylenediamine and formaldehyde.

Other Components

In one embodiment, the formulation further comprises a polyol such as castor oil. Castor oil is polyol that can be added to the formulation in order to modify the properties of the polyurethane. The addition of castor oil can make intermediate components of the formulation less viscous, which makes processing and mixing with the isocyanate easier. Other polyether or polyester polyols can be used. These can be difunctional or multifunctional. Examples of difunctional polyols include polyethylene glycol, hexane diol, and butane diol. Examples of polyether polyols include those offered by Bayer Material Science and known under the trade name ARCOL. In another embodiment, the formulation contains no polyol besides the brominated compound.

In one embodiment, the castor oil is present in a quantity ranging from 10% to 40% by mass of the formulation. In one embodiment, the formulation further comprises castor oil, wherein the castor oil is present in a quantity ranging from 10% to 35% by mass of the formulation. In one embodiment, the formulation further comprises castor oil, wherein the castor oil is present in a quantity ranging from 30% to 40% by mass of the formulation.

In one embodiment, the formulation further comprises a fire retardant compound selected from the group consisting of disodium ocataborate tetrahydrate, colemanite (CaB₃O₄(OH)₃.H₂O), ulexite (NaCaB₅O₆(OH)₆.5(H₂O)), aluminum trihydrate, magnesium hydroxide (Mg(OH)₂), hydromagnesite (Mg₅(CO₃)₄(OH)₂.4H₂O), hunitite (Mg₃Ca(CO₃)₄), zinc borate, and disodium decaborate.

In one embodiment, the formulation further comprises one or more additives, the one or more additives selected from the group consisting of surfactants, wetting agents, opacifying agents, colorants, moisture scavengers, viscosifying agents, catalysts, preservatives, fillers, diluents, hydrated compounds, halogenated compounds, acids, bases, salts, borates, melamine and other additives that might promote the production, storage, processing, application, function, cost and/or appearance of this fire retardant formulation for wood products.

Preparation of the Formulation

In one embodiment component intermediates can be utilized. For example an intermediate can be prepared based on a mixture of polyol and other compatible elements of the formulation. Sometimes a stable polyol-containing intermediate is referred to as “part A”. The part A components are added one at a time to the polyol or polyols. Each component is mixed with a high speed dispersion mixer with a cowls blade until completely dispersed before the next component is added. The intumescent particles are typically added last and are mixed more gently. The Part A mixture is then mixed with the part B isocyanate at the desired ratio. This can be done by hand, pumping through a static mix tube or a variety of commercially available meter mixing equipment.

Coated Wood Products

In another aspect, a fire-resistant wood product is provided. In one embodiment, the wood product comprises: a wood product having one or more surfaces; and a fire-resistant formulation as provided herein disposed on at least a portion of the one or more surfaces.

Coatings of the composition according to embodiments of the disclosure may be applied to a number of different products. As a non-limiting example, such coatings may be applied to wood products. Generally, coatings according to embodiments of the disclosure are applied to one or more surfaces of a wood product. In certain embodiments, coatings may be applied to a portion of one or more surfaces of the wood product. In certain embodiments, entire surfaces, or the entire surface, of wood product may be covered. In one embodiment, the fire-resistant coating covers 100% of each of the one or more surfaces.

In certain embodiments, the fire-resistant coating covers approximately 50% to approximately 100% of the product's surface area.

In one embodiment, the composition is disposed on a surface of a wood product.

In one embodiment, the surface of the wood product with the composition is flame-spread resistant such that it would pass the E 2768 flame spread test.

In one embodiment, the wood product is selected from the group consisting of: I-joists, trusses, glulam, solid sawn lumber, parallel strand lumber (PSL), oriented strand board (OSB), oriented strand lumber (OSL), laminated veneer lumber (LVL), laminated strand lumber (LSL), particleboard, cross-laminated timber, cross-laminated lumber, glulam beams, and medium density fiberboard (MDF).

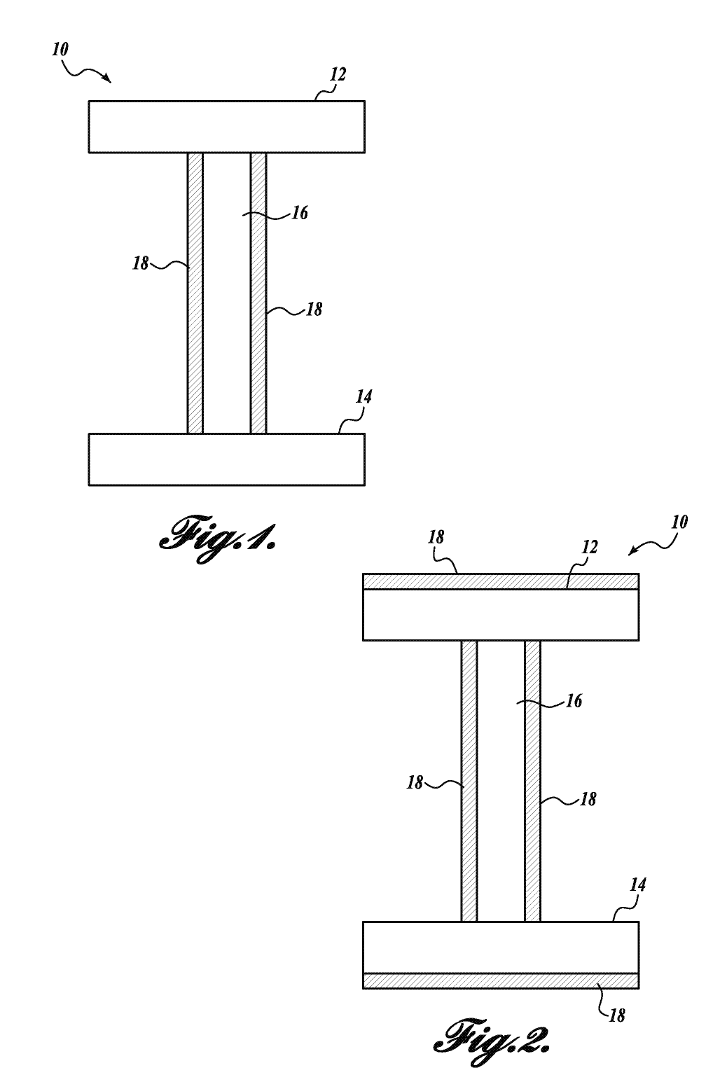

FIGS. 1-4 depict wood products having coatings of the compositions according to embodiments of the disclosure. FIGS. 1 and 2 show an I-joist 10 having a top flange 12, a bottom flange 14, and a webstock member 16 connecting the top flange 12 to the bottom flange 14. In FIG. 1, the webstock member 16 is shown completely coated in a coating 18 of a composition according to embodiments of the disclosure. Typically, any wood surface that is expected to be exposed to heat (e.g., fire) is coated. In certain embodiments, only a portion (e.g., 50% to 90%) of the webstock member 16 is coated. Although not explicitly shown in FIG. 1, some portion of overspray may be applied to the top flange 12 and/or the bottom flange 14.

Referring to FIG. 2, the I-joist 10 is shown in a state similar to that of FIG. 1, but also with, the top flange 12 and the bottom flange 14 coated with the composition according to embodiments of the disclosure. In certain embodiments, the coating covers 10% to 50% of the I-joist surface area. In other embodiments, the coating covers 51% to 100% of the I-joist surface area. A person of ordinary skill in the art will appreciate that numerous different application configurations for I-joists not shown explicitly in FIGS. 1 and 2 are within the scope of this disclosure.

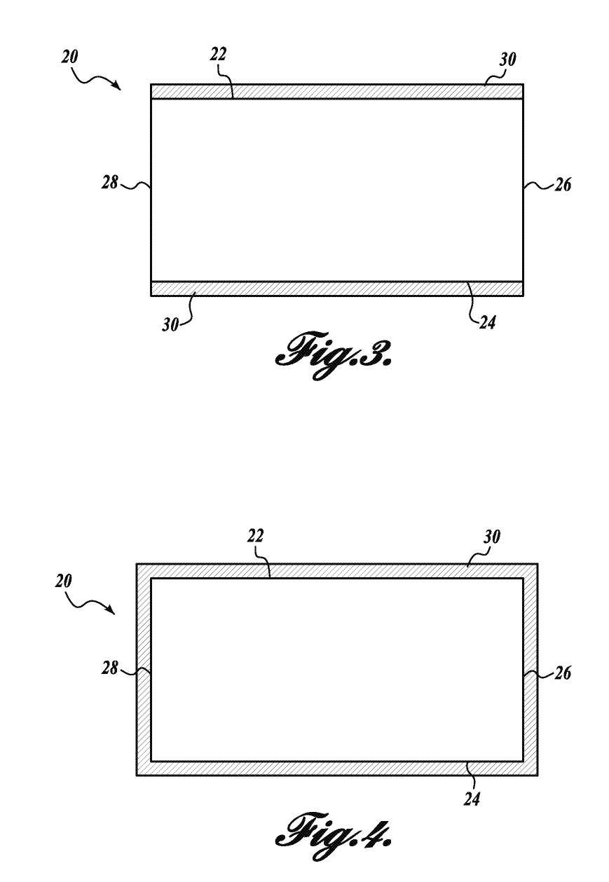

Referring to FIGS. 3 and 4, a wood element 20 is shown having a first surface 22, a second surface 24, a third surface 26, and a fourth surface 28. The wood element 20 may be any type of wood product, including but not limited to solid sawn lumber, parallel strand lumber (PSL), oriented strand board (OSB), oriented strand lumber, laminated veneer lumber (LVL), laminated strand lumber (LSL), particleboard, and medium density fiberboard (MDF). A person of ordinary skill in the art will appreciate that wood products according to this disclosure may have shapes other than those explicitly shown in the FIGURES.

Referring to FIG. 3, only the first surface 22 and the second surface 24 of the wood element 20 is coated with a coating 30 of a composition according to embodiments of the disclosure. The entire surfaces 22 and 24 may be coated or a portion may be coated.

In certain situations, it may be cost effective to coat only a portion of a surface of the wood element 20. For example, it is also possible that application of the coating 30 to a wood element 20 used as a building material could interfere with the ability of the wood element 20 to be connected or fastened, such as by nailing or screwing, to other building materials. In this situation, complete coverage of all of the exposed surface area on the wood element 20 may be undesirable.

Referring to FIG. 4, all four surfaces (the first surface 22, the second surface 24, the third surface 26, and the fourth surface 28) are coated with the coating 30. In certain situations, it may be desirable to cover each surface entirely or to cover only a portion of each surface. In certain embodiments, the coating 20 covers 10% to 50% of the wood element 20 surface area. In other embodiments, the coating 20 covers 51% to 100% of the wood element 20 surface area. A person of ordinary skill in the art will appreciate that numerous different application configurations for wood element 20 not shown explicitly in FIGS. 3 and 4 are within the scope of this disclosure.

It will also be appreciated that coatings made according to embodiments of the disclosure may be applied to different types of wood products other than those explicitly illustrated. For example, coatings may be applied to trusses or joists having any known configuration. In certain embodiments, wood products coated according to the disclosure include single sawn pieces of wood elements, or products having specific shapes. As a non-limiting example, coatings according to the disclosure may be applied to a variety of wood products (e.g., trusses) having a top flange, bottom flange, and one or more web stock members.

The application level of the coating may generally be in the range of 77.5 g/m² to 4650 g/m². In one embodiment, the level of coating is from 155 to 1550 g/m². In one embodiment, the level of coating is from 465 to 0.1085 g/M².

The preferred coating application level may depend on the element to which the coating is applied, the intended use, and performance requirements. In certain situations, minimal protection of the wood product might be needed and a relatively low spread rate may be suitable. In other situations (e.g., an exposed floor assembly), a higher application rate may be appropriate.

Coatings according to embodiments of the disclosure may be applied with any equipment known to those of skill in the art, such as spray systems, extruders, curtain coaters, and roll coaters, and other application equipment. In certain embodiments, coatings according to embodiments of the disclosure may be applied to any surface area described herein as a series of discrete beads using an extruder or another equivalent apparatus. Such beads may each be approximately ⅛ of an inch to approximately 1 inch in diameter and may be spaced so that they are approximately ⅛ of an inch to approximately ¼ of an inch apart.

In certain embodiments, the coating is applied manually with a hand-held knife or brush.

Although this disclosure explicitly describes applications of coatings to wood products, a person of ordinary skill in the art will appreciate that coatings made according to embodiments of the disclosure may be applied to different types of materials. As a non-limiting example, coatings of the provided compositions may be applied to other types of construction materials, including but not limited to wood/plastic composites, gypsum, steel (including light-gauge steel framing and steel beams and columns), aluminum (ducting), and concrete. Furthermore, coatings according to embodiments of the disclosure may be applied to surfaces other than constructions materials in any situation where the properties of the composition may be beneficial.

Words in the above disclosure using the singular or plural number may also include the plural or singular number, respectively. For example, the term “wood element” could also apply to “wood elements.” Additionally, the words “herein,” “above,” “below” and words of similar import, when used in this application, shall refer to this application as a whole and not to any particular portions of this application. When the word “or” is used in reference to a list of two or more items, that word covers all of the following interpretations of the word: any of the items in the list, all of the items in the list, and any combination of the items in the list.

From the foregoing, it will be appreciated that the specific embodiments of the disclosure have been described herein for purposes of illustration, but that various modifications may be made without deviating from the disclosure. For example, the compositions according to the disclosure may be impregnated in wood products or may be applied in a manner that is not considered a coating. In addition, coatings according to the disclosure may be used for reasons other than their low flame-spread properties.

Aspects of the disclosure described in the context of particular embodiments may be combined or eliminated in other embodiments. For example, aspects of the disclosure related to I-joists may be combined with aspects of the disclosure related to other wood products. Further, while advantages associated with certain embodiments of the disclosure may have been described in the context of those embodiments, other embodiments may also exhibit such advantages, and not all embodiments need necessarily exhibit such advantages to fall within the scope of the disclosure. Accordingly, the invention is not limited except as by the appended claims.

The following examples will serve to illustrate aspects of the present disclosure. The examples are intended only as a means of illustration and should not be construed to limit the scope of the disclosure in any way. Those skilled in the art will recognize many variations that may be made without departing from the spirit of the disclosure.

### Examples

### Exemplary Formulations

Four exemplary formulation coatings were prepared: WE84-125; WE84-148, WE84-178; and WE84-179. The coatings were first prepared according to the formulation tables below. To prepare the coatings for formulations WE84-125 and WE84-148 the components were added one at a time and mixed before the next component was added this continued until everything except the isocyanate was mixed into the formulation. This created the polyol side, or part A, of the formulation. The isocyanate component was added just prior to application to the substrate.

For formulations WE84-178 and WE84-179 the catalyst and isocyanate were mixed by hand. This made up the isocyanate side, or part B, of the formulation. Part A was prepared by mixing the components, with the exception of the isocyanate and catalyst, one at a time until all the components had been added. Just prior to applying the coating to the substrate the part A and part B formulations were mixed together.

WE84-125: 3:1 mix ratio (A:B)

| | | |
|---|---|---|
| | Percent Mass in | |
| Component | total formulation | Mixing |

Part A

| | | |
|---|---|---|
| Urethane grade castor oil | 26.5 | |
| Brominated polyol | 15.8 | 2 minutes on high |
| (PHT-4-Diol) | | with cowls blade |
| Disodium octaborate tetra | 11.5 | 3 minutes on high |
| hydrate (DOT) | | with cowls blade |
| Antimony trioxide | 5.9 | 1 minute on high |
| | | with cowls blade |
| Vinyl Silane | 0.71 | 1 minute on high |
| | | with cowls blade |
| Catalyst (polycat DBU) | 0.79 | 1 minute on high |
| | | with cowls blade |
| Expandable graphite | 13.8 | 2 minutes by hand |

Part B

| | |
|---|---|
| Isocyanate | 25.0 |

WE84-125: 2.5:1 mix ratio (A:B)

| | | |
|---|---|---|
| | Percent Mass in | |
| Component | total formulation | Mixing |

Part A

| | | |
|---|---|---|
| Urethane grade castor oil | 25.25 | |
| Brominated polyol | 15.05 | 2 minutes on high |
| (PHT-4-Diol) | | with cowls blade |
| Disodium octaborate tetra | 10.87 | 3 minutes on high |
| hydrate (DOT) | | with cowls blade |
| Antimony trioxide | 5.63 | 1 minute on high |
| | | with cowls blade |
| Vinyl Silane | 0.68 | 1 minute on high |
| | | with cowls blade |
| Catalyst (polycat DBU) | 0.75 | 1 minute on high |
| | | with cowls blade |
| Expandable graphite | 13.17 | 2 minutes by hand |

Part B

| | |
|---|---|
| Isocyanate | 28.60 |

WE84-148

| | | |
|---|---|---|
| | Percent Mass in | |
| Component | total formulation | Mixing |

Part A

| | | |
|---|---|---|
| Urethane grade castor oil | 27.8 | |
| Brominated polyol | 17.3 | 2 minutes on high |
| (PHT-4-Diol) | | with cowls blade |
| Titanium dioxide | 3.88 | 3 minutes on high |
| | | with cowls blade |
| Iron oxide | 3.74 | |
| Antimony trioxide | 6.5 | 1 minute on high |
| | | with cowls blade |
| Vinyl Silane | 0.78 | 1 minute on high |
| | | with cowls blade |
| Expandable graphite | 15.0 | 2 minutes by hand |

Part B

| | |
|---|---|
| Isocyanate | 25.0 |

WE84-178

| | | |
|---|---|---|
| | Percent Mass in | |
| Component | total formulation | Mixing |

Part A

| | | |
|---|---|---|
| Urethane grade castor oil | 20.20 | |
| Brominated polyol | 26.0 | 2 minutes on high |
| (PHT-4-Diol) | | with cowls blade |
| Titanium dioxide | 3.90 | 3 minutes on high |
| | | with cowls blade |
| Antimony trioxide | 10.20 | 1 minute on high |
| | | with cowls blade |
| Vinyl Silane | 0.77 | 1 minute on high |
| | | with cowls blade |
| Expandable graphite | 16.50 | 2 minutes by hand |

Part B

| | | |
|---|---|---|
| Isocyanate | 21.70 | 1 minute by hand |
| Catalyst K-Kat 6212 | 0.730 | 1 minute by hand |

WE84-179

| | | |
|---|---|---|
| | Percent Mass in | |
| Component | total formulation | Mixing |

Part A

| | | |
|---|---|---|
| Urethane grade castor oil | 18.2 | |
| Brominated polyol | 23.50 | 2 minutes on high |
| (PHT-4-Diol) | | with cowls blade |
| Titanium dioxide | 3.5 | 3 minutes on high |
| | | with cowls blade |
| Antimony trioxide | 9.2 | 1 minute on high |
| | | with cowls blade |
| Vinyl Silane | 1.4 | 1 minute on high |
| | | with cowls blade |
| Expandable graphite | 14.9 | 2 minutes by hand |

Part B

| | | |
|---|---|---|
| Isocyanate | 28.6 | 1 minute by hand |
| Catalyst K-Kat 6212 | 0.7 | 1 minute by hand |

The Exemplary Formulations were tested for fire resistance according to E-84. The test was performed by coating the formulation. The coating was applied to TimberStrand® LSL rimboard at a spread rate of 0.54 g/ft². The mixing of part A with part B was done by hand and the coating was applied by hand brushing

WE84-179 passed the 30 minute extended E-84 test with the following performance:

Smoke developed: 150 (unitless);

Time to ignition: 7 minutes, 3 seconds;

Flame distance at 10 minutes: 4.5 feet; and

Flame distance at 30 minutes: 8.5 feet.

### Comparative Formulation

A formulation that did not pass the 30 minute E-84 test is W8011, which contains no brominated polyurethane components but is otherwise similar to the Exemplary Formulations. The formulation is provided below.

W8011

| | Percent Mass in |
|---|---|
| Component | total formulation |
| Castor oil | 31.69 |
| Titanium dioxide | 4.11 |
| Silicone oil | 0.19 |
| Reactint Red X-64 | 0.04 |
| Reactint Yellow X-15 | 1.92 |
| Reactint Blue X17AB | 0.01 |
| Urethane Catalyst | 0.75 |
| Fumed Silica | 0.51 |
| Expandable graphite | 23.08 |
| Isocyanate (pMDI) | 37.7 |

The 30 minute extended E-84 test of W8011 included the following performance:

Smoke developed: 85 (unitless);

Ignition time: 27 seconds;

Flame distance at 10 minutes: 8.9 feet; and

Flame distance at 30 minutes: 22.5 feet.

Comparing the extended E-84 test of comparative W8011 to exemplary WE84-179 illustrates the dramatic improvement in fire resistance provided by coatings formed according to the disclosed embodiments.

While illustrative embodiments have been illustrated and described, it will be appreciated that various changes can be made therein without departing from the spirit and scope of the invention.

The embodiments of the invention in which an exclusive property or privilege is claimed are defined as follows:

1. A fire-resistant formulation for a wood product, comprising a polyurethane matrix comprising:
an isocyanate, wherein the isocyanate is present in a quantity ranging from 15% to 40% by mass of the formulation;
a brominated compound that is reactive with the isocyanate to form a polyurethane, wherein the brominated compound is present from about 10% to 80% by mass of the formulation;
an intumescent component, wherein the intumescent component is present in a quantity ranging from 1% to 25% by mass of the formulation; and
a fire-retardant synergist, wherein the synergist is present in a quantity ranging from 0.25% to 15% by mass of the formulation.

2. The fire-resistant formulation of claim 1, wherein the isocyanate is present in a quantity ranging from 20% to 35% by mass of the total formulation.

3. The fire-resistant formulation of claim 1, wherein the isocyanate is an aromatic isocyanate selected from the group consisting of toluene diisocyanate (TDI), monomeric methylene diphenyldiisocyanate (MDI), polymeric methylenediphenyldiisocyanate (pMDI), 1,5′-naphthalenediisocyante, prepolymers of TDI, and prepolymers of pMDI.

4. The fire-resistant formulation of claim 1, wherein the isocyanate is an aliphatic isocyanate selected from the group consisting of hexamethylene diisocyanate (HDI) and isophorone diisocyanate (IPDI).

5. The fire-resistant formulation of claim 1, wherein the brominated compound is present from about 15% to 30% by mass of the formulation.

6. The fire-resistant formulation of claim 1, wherein the brominated compound is selected from the group consisting of tetrabromophthalate diol, brominated neopentyl alcohol, and brominated neopentyl glycol.

7. The fire-resistant formulation of claim 1, wherein the intumescent component is present in a quantity ranging from 5% to 25% by mass of the formulation.

8. The fire-resistant formulation of claim 1, wherein the intumescent component is selected from the group consisting of expandable graphite, perlite ore, and vermiculite ore.

9. The fire-resistant formulation of claim 1, wherein the fire-retardant synergist is present in a quantity ranging from 1% to 10% by mass of the formulation.

10. The fire-resistant formulation of claim 1, wherein the fire-retardant synergist is selected from the group consisting of hallosite clay, antimony trioxide, antimony pentaoxide, colloidal antimony pentoxide, sodium antimonite or other antimony-metal compounds, antimony compounds that contain silicone or phosphorous, zinc hydroxy stannate, and mixtures thereof.

11. The fire-resistant formulation of claim 1, wherein the fire-retardant synergist is selected from the group consisting of salts of boron-containing acids and bromine-containing amines.

12. The fire-resistant formulation of claim 1, further comprising castor oil, wherein the castor oil is present in a quantity ranging from 10% to 40% by mass of the formulation.

13. The fire-resistant formulation of claim 1, further comprising a fire retardant compound selected from the group consisting of disodium ocataborate tetrahydrate, colemanite (CaB₃O₄(OH)₃.H₂O), ulexite (NaCaB₅O₆(OH)₆.5(H₂O)), aluminum trihydrate, magnesium hydroxide (Mg(OH)₂), hydromagnesite (Mg₅(CO₃)₄(OH)₂.4H₂O), hunitite (Mg₃Ca(CO₃)₄), zinc borate, and disodium decaborate.

14. The fire-resistant formulation of claim 1, further comprising one or more additives, the one or more additives selected from the group consisting of: silica, surfactants, wetting agents, opacifying agents, colorants, viscosifying agents, catalysts, preservatives, fillers, diluents, hydrated compounds, halogenated compounds, acids, bases, salts, and melamine.

15. A fire-resistant wood product, comprising:
a wood product having one or more surfaces; and
a fire-resistant formulation of claim 1 disposed on at least a portion of the one or more surfaces.

16. The fire-resistant wood product of claim 15, wherein the fire-resistant formulation is present in a quantity ranging from 0.05 grams per square inch to 3.0 grams per square inch.

17. The fire-resistant wood product of claim 15, wherein the fire-resistant formulation covers 100% of each of the one or more surfaces.

18. The fire-resistant wood product of claim 15, wherein the wood product is selected from the group consisting of I-joists, trusses, glulam, solid sawn lumber, parallel strand lumber (PSL), oriented strand board (OSB), oriented strand lumber (OSL), laminated veneer lumber (LVL), laminated strand lumber (LSL), particleboard, cross-laminated timber, cross-laminated lumber, glulam beams, and medium density fiberboard (MDF).

19. A fire-resistant I-joist formed from one or more wood products, comprising:
a top flange;
a bottom flange; and
one or more webstock members connecting the top flange to the bottom flange;
wherein at least a portion of the I-joist is coated in a fire-resistant formulation of claim 1.

20. The fire-resistant wood product of claim 19, wherein 50% to 100% of the wood product's surface is coated in the fire-resistant formulation.
